(19) United States
(12) Patent Application Publication
(10) Pub. No.: US 2023/0352967 A1
(43) Pub. Date: Nov. 2, 2023

(54) Solar-Powered Protective Cell Phone Case and Method of Use

(71) Applicant: Ronald Torres, Camden, NJ (US)

(72) Inventor: Ronald Torres, Camden, NJ (US)

(21) Appl. No.: 18/297,026

(22) Filed: Apr. 7, 2023

Related U.S. Application Data
(60) Provisional application No. 63/335,289, filed on Apr. 27, 2022.

(51) Int. Cl. H02J 7/35; H02J 7/00; H04M 1/72409

(52) U.S. Cl. CPC H02J 7/35; H02J 7/00712; H02J 7/0048; H02J 7/0044; H04M 1/724092

(57) ABSTRACT

The present invention is a multifunctional cell phone case configured for providing protection to a cell phone while also providing charging for a battery of the cell phone. The case includes a plurality of solar cells integrated onto an exterior of the rear surface thereof for absorbing sunlight and converting same into electrical energy to charge phone. The case has a dust cover flap on the bottom wall thereof that has a charging port such as a micro-USB port which plugs into the charging connector of the phone, transferring electric power generated from the solar energy to the phone for charging. This invention offers a sustainable and eco-friendly way to charge the cell phone, making it a practical and innovative solution for modern-day smartphone users.

### CROSS-REFERENCE TO RELATED APPLICATION

The present application claims priority to, and the benefit of, U.S. Provisional Application No. 63/335,289, which was filed on Apr. 27, 2022, and is incorporated herein by reference in its entirety.

### FIELD OF THE INVENTION

The present invention relates generally to the field of cell phone covers. More specifically, the present invention relates to a novel cell phone case which is used for charging a cell phone while providing protection from physical damage and weather elements. The phone case has solar cells that generate electric power which is provided to a cell phone accommodated in the case using a charging port integrated in a dust cover flap of the case. Accordingly, the present disclosure makes specific reference thereto. Nonetheless, it is to be appreciated that aspects of the present invention are also equally applicable to other like applications, devices, and methods of manufacture.

### BACKGROUND

By way of background, electronic devices such as cell phones have revolutionized the way we communicate, work, and entertain ourselves. People spend a lot of time using their smartphones not just for making phone calls and sending text messages, but also for a variety of other tasks such as browsing the Internet, playing games, running personal-use programs, and business-use programs and many more. Such frequent and regular use of cell phones require people to regularly recharge the battery of such devices. However, the need to charge these devices regularly has become a source of frustration and inconvenience for many users. Recharging such cell phones generally requires an electrical outlet for providing electric power. However, people lack access to an electrical outlet when their device needs to be charged while commuting, trekking, or other remote outdoor activities, and more, or otherwise due to unavailability of electricity. Even while charging cell phones with an electrical outlet, dealing with charging cables and outlet plugs can lead to tangles and frustration.

Many people carry power banks or wireless chargers for charging compatible cell phones. However, carrying a separate device for charging is troublesome for users. Further, people have to separately purchase a power bank or wireless charger which is not only expensive, but can also require maintenance. People desire a solution that eliminates use of power banks and wireless chargers for charging cell phones.

Recharging of cell phones conventionally requires electric power which is not environmentally friendly as fossil fuels are used in production of electricity. People desire a practical and innovative solution that solves the problem of inconvenient charging methods, especially in light of the increased use of smartphones while promoting sustainability and reducing their carbon footprint.

Therefore, there exists a long-felt need in the art for a charging device that enables users to charge their phones anywhere, without the need for an electrical outlet or charging cables. There is also a long-felt need in the art for a device that enables users to charge their phones while promoting sustainability and reducing their carbon footprint easily and conveniently. Additionally, there is a long-felt need in the art for a novel cell phone charging device that solves common problem associated with conventional charging methods. Moreover, there is a long-felt need in the art for a device that charges a cell phone and is secured to cell phone, thereby obviating requirement of carrying a separate charging device, such as power banks and wireless chargers. Finally, there is a long-felt need in the art for a cell phone charging device that enables a hands-free and cord-free method of charging a cell phone.

The subject matter disclosed and claimed herein, in one embodiment thereof, comprises a solar-powered cell phone case for protecting and charging a cell phone. The cell phone case has a plurality of weatherproof solar cells disposed on the back surface of the phone case, each solar cell is configured to absorb solar energy from both natural and artificial light and convert it into electric power, a dust cover flap disposed on the bottom edge of the case, the dust cover flap having an integrated charging port oriented towards the interior housing of the case, the charging port forms an electrical connection with the charging connector of the cell phone when dust cover flap is closed, wherein the charging port provides electric power to the cell phone to recharge the battery of the cell phone and the electric power is generated from the absorbed solar energy.

In this manner, the multifunctional cell phone case of the present invention accomplishes all of the forgoing objectives and provides users with an improved, waterproof cell phone case designed to charge the phone via solar power. A micro-USB port of the phone case is plugged into the cell phone's charging port to draw power from the solar cells for charging battery of the cell phone. The phone case eliminates requirements of carrying separate charging device and use of an electrical outlet for charging a cell phone and therefore, enables a hands-free and cord-free method of charging a cell phone.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a solar-powered cell phone case for protecting and charging a cell phone. The cell phone case is a rectangular-shaped housing with a top wall, a bottom wall, and a pair of side walls that extend vertically to cover and protect the side edges of a cell phone, a plurality of weatherproof solar cells disposed on the back surface of the phone case, each solar cell is configured to absorb solar energy from both natural and artificial light and convert it into electric power, a dust cover flap disposed on the bottom edge of the housing, the dust cover flap having an integrated charging port oriented towards the interior housing of the case, the charging port being compatible with the charging connector of the cell phone, enabling an electrical connection of the port and the charging connector of the cell phone, wherein the charging port provides electric power to the cell phone to recharge battery of the cell phone.

In yet another embodiment, the solar-powered cell phone case is made of waterproof material, including soft silicone or rubber material for providing a secure seal to prevent the phone from weather elements.

In yet another embodiment, the cell phone case has a top surface for covering display or top surface of the cell phone.

In yet another embodiment, a method of charging a cell phone using a solar-powered cell phone case without using any cord or wire is described. The method includes the steps of attaching the solar-powered cell phone case to the cell phone, wherein the case comprises a plurality of weatherproof solar cells disposed on the back surface thereof; opening a dust cover flap of the case to reveal an integrated charging port, wherein the dust cover flap is positioned on the bottom wall of the case and has an integrated charging port compatible to charging connector of the cell phone; passing the charging port through a cut-out in the bottom wall; plugging the charging port of the case into the charging connector of the cell phone; and, providing charging to the cell phone using electric power converted from the solar cells.

In yet another embodiment, a solar-powered cell phone case is disclosed. The cell phone case having a top surface and a back surface, the protective phone case being made of waterproof material, a plurality of photovoltaic solar cells disposed on the back surface of the protective cover and configured to absorb solar energy from both natural and artificial light sources and convert it into electric power, a dust cover flap disposed around the bottom wall and having an integrated charging port, and charging circuitry for transferring solar energy from the solar cells to the charging connector of the cell phone when the dust cover flap is plugged into the charging connector of the cell phone.

In yet another embodiment, the solar-powered and protective solar case of the present invention is easily and efficiently manufactured, marketed, and available to consumers in cost-effective manner and is easily used by users for hands-free and cord-free method of charging a cell phone.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a multifunctional cell phone case of the present invention in accordance with the disclosed architecture;

FIG. 2 illustrates a top view showing a smartphone being protected by the case of FIG. 1 and charging using the charging port of the case in accordance with the disclosed architecture;

FIG. 3 illustrates a schematic view showing essential components integrated in the phone solar charging case of different embodiments of the present invention in accordance with the disclosed architecture;

FIG. 4 illustrates another embodiment of the solar charging case of the present invention for cellular phones in accordance with the disclosed architecture; and

FIG. 5 illustrates a flow chart depicting a process of providing electric charge by the solar charging case of different embodiments of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is long-felt need in the art for a charging device that enables users to charge their phones anywhere, without the need for an electrical outlet or charging cables. There is also a long-felt need in the art for a device that enables users to charge their phones while promoting sustainability and reducing their carbon footprint easily and conveniently. Additionally, there is a long-felt need in the art for a novel cell phone charging device that solves common problem associated with conventional charging methods. Moreover, there is a long-felt need in the art for a device that charges a cell phone and is secured to cell phone, thereby obviating requirement of carrying a separate charging device such as power banks and wireless chargers. Finally, there is a long-felt need in the art for a cell phone charging device that enables a hands-free and cord-free method of charging a cell phone.

The present invention, in one exemplary embodiment, is a solar-powered cell phone case. The cell phone case is made of waterproof material, the case has a plurality of photovoltaic solar cells disposed on the back surface and solar cells are configured to absorb solar energy from both natural and artificial light sources and convert it into electric power, a dust cover flap disposed around the bottom wall and having an integrated charging port, and charging circuitry for transferring solar energy from the solar cells to the charging connector of the cell phone when the dust cover flap is plugged into the charging connector of the cell phone.

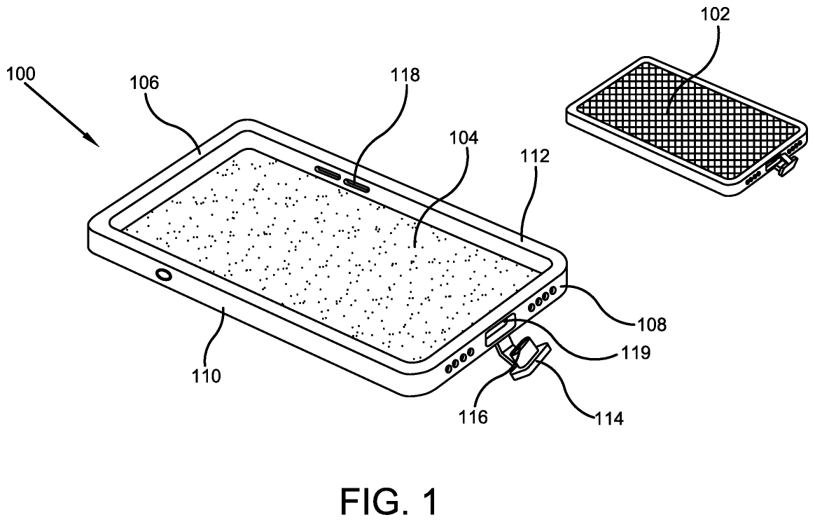

Referring initially to the drawings, FIG. 1 illustrates a perspective view of one potential embodiment of multifunctional cell phone case of the present invention in accordance with the disclosed architecture. The solar-powered cell phone case 100 of the present invention is designed to integrate solar cells and a charging port for providing charging to a phone protected by the case 100 without requiring an electrical outlet or any additional charging device such as a power bank, wireless charger, and the like. The phone case 100 can be designed in multiple sizes, designs, and configurations to fit and become compatible with different cell phones offered by cell phone manufacturers. More specifically, in the present embodiment, the phone charger case 100 has a plurality of weatherproof solar cells 102 disposed on the back surface 104 of the case 100. The solar cells 102 are configured to absorb solar energy from both natural light and artificial light and convert into electric power for providing charging to a cell phone.

The solar cells 102 are conventional photovoltaic cells and have a built-in mechanism for conversion to electric energy. In the preferred embodiment, the phone case 100 can store up to 8000 mAh in a 30-minute solar charge enabling a user to easily charge their phone batteries using the case 100. A milliampere hour (mAh) is 1000th of an ampere hour (Ah). Both measures are commonly used to describe the energy charge that a battery will hold and how long a device will run before the battery needs recharging. Structurally, the case 100 has a rectangular shape to conform to a shape of a smartphone and has a top wall 106, a bottom wall 108, and a pair of side walls 110, 112. All the walls extend vertically as perimeter walls from the back surface to cover and protect side edges of an accommodating cell phone. The bottom edge 108 has a dust cover flap 114 disposed around the center thereof, wherein the dust cover flap 114 aligns with a female charging connector/port 117 of the smartphone. The dust cover flap 114 includes an integrated male charging connector/port 116 oriented towards the interior housing of the case 100. The male charging connector/port 116 is compatible to the female charging connector/port 117 of the smartphone enabling an electrical connection of the male charging connector/port 116 and the female charging connector/port 117 of the smartphone. By way of example and not limitation, the male charging connector/port 116 can be a micro-USB connector, type C-charger, USB connector, mini-USB connector or any other connector/port known in the art and is used by cell phones for charging. Embodiments of the present invention are intended to include or otherwise cover any type of the charging port for the case 100 including known, related art, and/or later developed technologies. The micro-USB port 116 transfers solar energy to the phone for charging when plugged into the charging connector of the phone, and therefore, provides charging without requiring cords and external charging devices.

The cell phone charger case 100 can be longer (i.e., ¼″ longer) than the cell phone for which the charger case 100 is designed, thereby accommodating the male charging connector/port 116 when the case 100 is installed on a cell phone for protecting the cell phone. The dust flap cover 114 also serves as a protective cover for the charging port on the cell phone device, preventing dust, dirt, and other debris from entering and potentially causing damage or interfering with the function of the device. The dust flap cover 114 also protects the male charging connector/port 116 from physical damage and from dust, dirt, and other debris. It should be noted that the dust flap cover 114 remains in a closed position as illustrated in the present embodiment, when charging a cell phone and for removing the case 100, the dust flap cover 114 is removed from the corresponding opening or cut-out 119 to pull the male connector/port 116 from the female connector/port 117 from the cellular phone in order to unplug the charger case 100 from the cellular phone.

The case 100 is made of waterproof material including, but not limited to, soft silicone or rubber material for providing a secure seal to prevent the phone from weather elements. The case 100 is configured to be used in a conventional manner to cover and protect a cellular phone while providing electric power to recharge the battery of the cellular phone. It should be appreciated that the case 100 can have a plurality of other openings 118 as well for enabling a user to operate the phone while the case 100 is installed thereon.

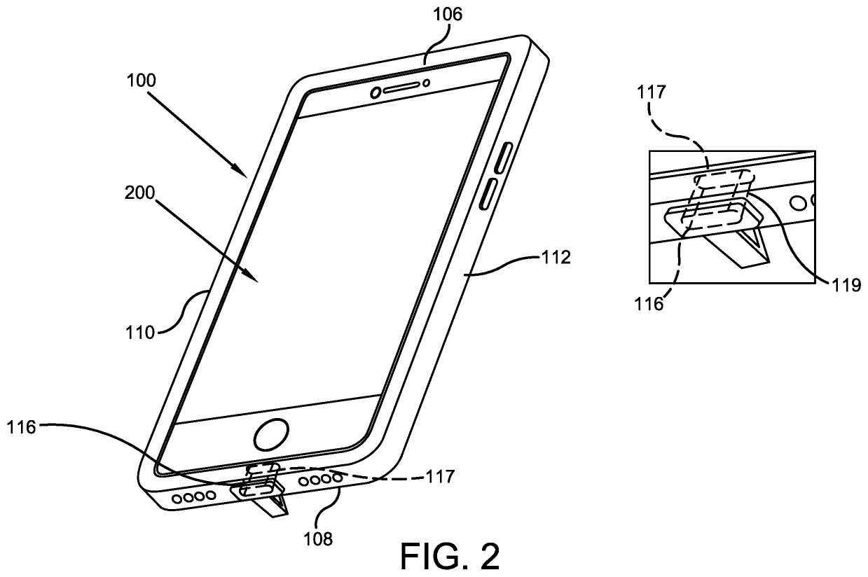

FIG. 2 illustrates a top view showing a smartphone being protected by the case of FIG. 1 and charging using the charging connectors/ports of the case in accordance with the disclosed architecture. As illustrated, the male charging connector/port 116 is plugged into the charging connector 117 of the cellular phone 200 which is protected by the case 100. The walls 106, 108, 110, 112 cover the side edges of the smartphone 200 and functions like a conventional weatherproof case for the phone 200. The male charging connector/port 116 is designed to be compatible with power requirements of the phone 200 and the male charging connector/port 116 can remain plugged into the female connector/port 117 for long periods of time. For disconnecting the charger, the dust cover flap 114 can be unplugged while remaining attached to the bottom wall 108 of the case 100.

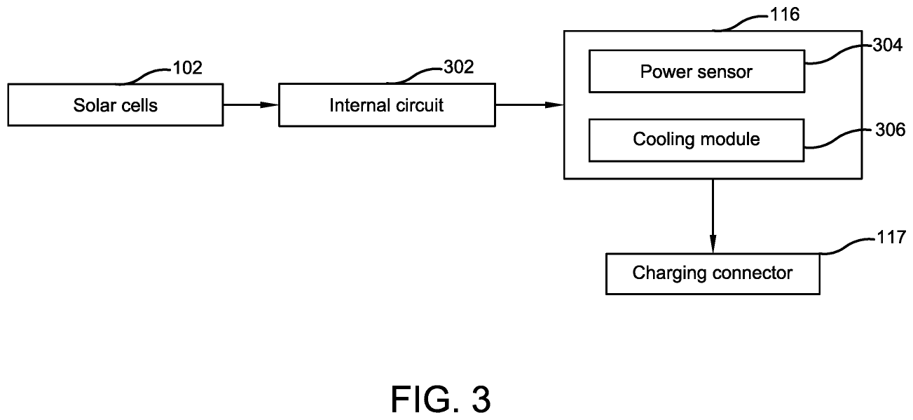

FIG. 3 illustrates a schematic view showing essential components integrated in the phone solar charging case of different embodiments of the present invention in accordance with the disclosed architecture. The charging case of different embodiments has solar cells 102 for absorbing solar energy and converting same into electric power. The solar cells 102 are internally coupled to internal circuit 302 disposed in the case for carrying the converted electric power to the male charging connector/port 116. The internal circuit 302 is not visible from outside and thereby maintains aesthetic appeal of the case 100 while also providing protection to a user. The connecting port 116 has an integrated power sensor 304 for sensing battery level of a connecting smartphone. The power sensor 304 automatically slows down charging when the battery level of the connected cellular phone reaches 90% of the total battery level.

A cooling module 306 is also disposed inside the male charging connector/port 116 for preventing any overheating during charging process. This enables a user to keep the male charging connector/port 116 plugged in for long periods without fear of overheating. Further, the male charging connector/port 116 is configured to match the power requirements of the battery of a smartphone for which the charging case 100 is designed for providing effective charging.

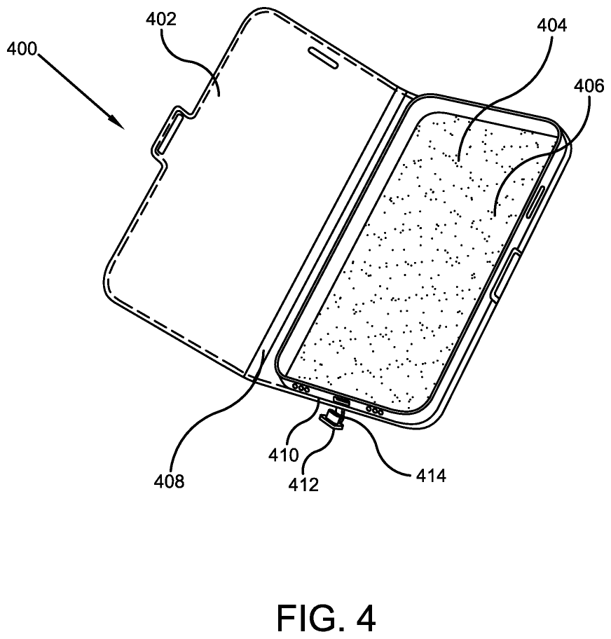

FIG. 4 illustrates another embodiment of the solar charging case of the present invention for cellular phones in accordance with the disclosed architecture. In the present embodiment, the charging case 400 has a top surface 402 and a back surface 404. The top surface 402 is configured to cover a display or a top surface of a cellular phone and the back surface 404 is configured to cover the rear surface of the cellular phone. The back surface 404 has a plurality of solar cells 406 for absorbing solar energy and converting same into electric power. The top surface 402 and the back surface 404 can be hinged along a common edge 408 for enabling a cellular phone to be easily accommodated therein for protection and charging. The bottom wall 410 of the back surface 404 has a dust flap cover 412 with integrated male charging port 414 for plugging into female charging connector/port of a cellular phone (not illustrated) accommodated by the case 400 and providing the electric charge converted by the solar cells 406 without requiring any external cord or charging device.

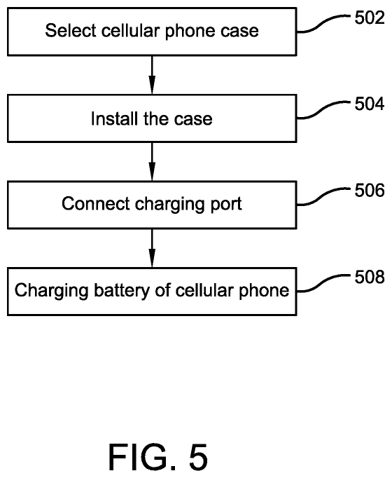

FIG. 5 illustrates a flow chart depicting a process of providing electric charge by the solar charging case of different embodiments of the present invention in accordance with the disclosed architecture. Initially, a charging case for a cellular phone is selected, with the case being compatible with the cellular phone (Step 502). Then, the case is installed and the cellular phone is accommodated in the case (Step 504). Thereafter, the male charging port connected to the dust cover flap is inserted into the female charging connector of the cellular phone when the case is installed (Step 506). Finally, the electric power converted from the solar energy by solar cells is provided through the male charging port to charge the cellular phone (Step 508).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “solar charging case”, “charging case”, “multifunctional cell phone case”, “case”, and “solar-powered cell phone case” are interchangeable and refer to the solar-powered cell phone protective case 100, 400 of the present invention.

Notwithstanding the forgoing, the solar-powered cell phone protective case 100, 400 of the present invention can be of any suitable size and configuration as is known in the art without affecting the overall concept of the invention, provided that it accomplishes the above-stated objectives. One of ordinary skill in the art will appreciate that the solar-powered cell phone protective case 100, 400 as shown in the FIGS. are for illustrative purposes only, and that many other sizes and shapes of the solar-powered cell phone protective case 100, 400 are well within the scope of the present disclosure. Although the dimensions of the solar-powered cell phone protective case 100, 400 are important design parameters for user convenience, the solar-powered cell phone protective case 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A solar-powered cell phone case comprising:
a top wall;
a bottom wall;
a pair of side walls;
a back surface;
a plurality of solar cells on an exterior side of said back surface; and
a male charging connector attached to said bottom wall;
wherein said plurality of solar cells are waterproof;
wherein said plurality of solar cells are photovoltaic cells;
wherein said bottom wall having a cut-out for extending said male charging connector therethrough;
wherein said cut-out providing access to a female charging port of a cell phone;
wherein said male charging connector oriented towards an interior housing of said solar-powered cell phone case; and
further wherein an electrical connection is enabled between said male charging connector and said female charging port when said male charging connector is inserted into said female charging port.

2. The solar-powered cell phone case of claim 1, wherein said solar-powered cell phone case storing up to 8000 mAh.

3. The solar-powered cell phone case of claim 2, wherein said 8000 mAh store is obtained in a 30-minute solar charge.

4. The solar-powered cell phone case of claim 2, wherein said male charging connector attached to a dust cover flap.

5. The solar-powered cell phone case of claim 4, wherein said dust cover flap attached to said bottom wall.

6. The solar-powered cell phone case of claim 5, wherein said dust cover flap and said male charging connector port aligned with said female charging port of the cell phone.

7. The solar-powered cell phone case of claim 6, wherein said male charging connector selected from a group consisting of a micro-USB connector, a type C-charger, a USB connector, and a mini-USB connector.

8. The solar-powered cell phone case of claim 7, wherein said male charging connector transfers solar energy to said female charging port of the cell phone and charges a battery of the cell phone when said male charging connector is inserted into said female charging port.

9. A solar-powered cell phone case comprising:
a top wall;
a bottom wall;
a pair of side walls;
a back surface;
a plurality of solar cells on an exterior side of said back surface; and
a male charging connector attached to said bottom wall;
wherein said plurality of solar cells are waterproof;
wherein said plurality of solar cells are photovoltaic cells;
wherein said bottom wall having a cut-out for extending said male charging connector therethrough;
wherein said cut-out providing access to a female charging port of a cell phone;
wherein said male charging connector oriented towards an interior housing of said solar-powered cell phone case;
wherein an electrical connection is enabled between said male charging connector and said female charging port when said male charging connector is inserted into said female charging port; and
further wherein said male charging connector transfers solar energy to said female charging port of the cell phone and charges a battery of the cell phone when said male charging connector is inserted into said female charging port.

10. The solar-powered cell phone case of claim 9, wherein said male charging connector attached to a dust cover flap.

11. The solar-powered cell phone case of claim 10, wherein said dust cover flap attached to said bottom wall.

12. The solar-powered cell phone case of claim 11, wherein said dust cover flap and said male charging connector port aligned with said female charging port of the cell phone.

13. The solar-powered cell phone case of claim 12, wherein said male charging connector selected from a group consisting of a micro-USB connector, a type C-charger, a USB connector, and a mini-USB connector.

14. The solar-powered cell phone case of claim 13, wherein said solar-powered cell phone case storing up to 8000 mAh.

15. The solar-powered cell phone case of claim 14, wherein said 8000 mAh store is obtained in a 30-minute solar charge.

16. A method for charging a battery of a cell phone, the method comprising the steps of:
providing a solar-powered cell phone case having a top wall, a bottom wall, a pair of side walls, a back surface, a plurality of solar cells on an exterior side of said back surface, and a male charging connector attached to said bottom wall;
wherein said plurality of solar cells are waterproof;
wherein said plurality of solar cells are photovoltaic cells;
exposing said plurality of solar cells to sunlight;
placing a cell phone within said top wall, said bottom wall, and said pair of side walls;
extending said male charging connector through a cut-out in said bottom wall;
wherein said cut-out providing access to a female charging port of a cell phone;
wherein said male charging connector oriented towards an interior housing of said solar-powered cell phone case;
inserting said male charging connector into said female charging port;
enabling an electrical connection between said male charging connector and said female charging port when said male charging connector is inserted into said female charging port; and
transferring solar energy from said male charging connector to said female charging port of the cell phone; and
charging a battery of the cell phone when said male charging connector is inserted into said female charging port.

17. The method for charging a battery of a cell phone of claim 16, wherein said male charging connector attached to a dust cover flap.

18. The method for charging a battery of a cell phone of claim 17, wherein said dust cover flap attached to said bottom wall.

19. The method for charging a battery of a cell phone of claim 18, wherein said dust cover flap and said male charging connector port aligned with said female charging port of the cell phone.

20. The method for charging a battery of a cell phone of claim 19, further comprising the steps of:
sensing a battery level of said battery of the cell phone; and
slowing down charging of said battery when said battery level of the cell phone reaches 90% of the total battery level.
